(19) United States
(12) Patent Application Publication
(10) Pub. No.: US 2003/0156545 A1
(43) Pub. Date: Aug. 21, 2003

(54) Signal paths providing multiple test configurations

(76) Inventors: Masashi Shimanouchi, Sunnyvale, CA (US); Howard Maassen, San Jose, CA (US)

Correspondence Address: FISH & RICHARDSON P.C., 500 ARGUELLO STREET, SUITE 500, REDWOOD CITY, CA, 94063, US

(21) Appl. No.: 10/371,353

(22) Filed: Feb. 18, 2003

Related U.S. Application Data
(60) Provisional application No. 60/357,343, filed on Feb. 15, 2002.

(51) Int. Cl. H04J 1/16

(52) U.S. Cl. 370/241

(57) ABSTRACT

Method and apparatus for circuit testing with signal paths providing multiple test configurations. Circuitry for use in testing electronic circuits includes switching circuitry operable to be controlled to make one of a first signal path and a second signal path. The first signal path is configured to carry a signal between a first node and a second node. The second signal path is configured to carry a signal between the first node and a third node. Each of the signal paths includes a portion that is located in pin electronics. The first node is connectable to a first pin of a device under test. The second node is connectable to a second pin of a device under test. The third node is connectable to an electronic instrument.

This application claims the benefit of U.S. Provisional Application No. 60/357,343, filed Feb. 15, 2002, which is herein incorporated by reference in its entirety

### BACKGROUND OF THE INVENTION

The present invention relates to electronic circuit testing.

Systems for testing electronic circuits, or simply test systems, can generally be used to test integrated circuit (“IC”) devices. An automatic test equipment (“ATE”) system is one example of a test system.

A test system typically includes pin electronics, which are circuits that are coupled to the pins or other nodes of an IC device being tested, generally referred to as the “device under test” or DUT. The pin electronics is the circuitry that stimulates the DUT and detects output signals from the DUT. Through the pin electronics, stimulus signals or waveforms are supplied to the DUT, and output signals or waveforms from the DUT are detected and measured. There are usually pin electronics for each pin of the DUT. The pin electronics for each pin of the DUT generally include a driver and a comparator and, furthermore, are usually contained in a testhead of the test system. Pin electronics usually interface with the DUT through a load board, on which the DUT is mounted. In one architecture, the pin electronics is the circuitry between a mainframe of the test system and the load board. FIG. 1 shows an example of this implementation.

High speed devices, for example, serial data communication links or serialcom devices, present a significant challenge to conventional test systems. High speed devices include those that operate at or faster than one gigabits per second. What differentiate these devices from other devices are their extremely high data rate, jitter testing requirements, and the typical packaging of a data source, for example, a transmitter, and receiver into a single package. Examples of serialcom devices include but are not limited to the MAX3880 and the MAX3890 (both available from Maxim Integrated Products, Inc.), PCI Express™ devices, and Infiniband® devices.

### SUMMARY OF THE INVENTION

The present invention provides methods and apparatus, including computer program products, for providing signal paths that provide multiple test configurations.

In general, in one aspect, circuitry for use in testing electronic circuits includes switching circuitry operable to be controlled to make one of a first signal path and a second signal path. The first signal path is configured to carry a signal between a first node and a second node. The second signal path is configured to carry a signal between the first node and a third node. Each of the signal paths includes a portion that is located in pin electronics. The first node is connectable to a first pin of a device under test. The second node is connectable to a second pin of a device under test. The third node is connectable to an electronic instrument.

In general, in another aspect, a computer-implemented method, for configuring pin electronics, includes receiving input that specify one or more tests. The method includes selecting, for each test, a configuration of a switching circuitry of the pin electronics. The configuration is any combination of a loop back configuration, a voltage leveling configuration, a jitter measurement configuration, and a jitter injected configuration. The method includes configuring the switching circuitry according to the selected configuration.

In general, in another aspect, a computer program product, for controlling pin electronic circuitry, includes instructions operable to cause the pin electronic circuitry to receive input that specify one or more tests. The product includes instructions to select, for each test, a configuration of a switching circuitry of the pin electronics. The configuration is any combination of a loop back configuration, a voltage leveling configuration, a jitter measurement configuration, and a jitter injected configuration. The product includes instructions to configure the switching circuitry to the selected configuration. The product is tangibly embodied in any combination of a machine-readable medium and a propagated carrier signal.

In general, in another aspect, an IC test system in accordance with the invention includes a signal path connecting an output of a comparator either to an input of a driver, to an external instrument, or to both the input of the driver and the external instrument. The output of the driver is connectable to a receive pin of a device under test. The input of the comparator is connectable either to a transmit pin of the device under test or to an external data source.

In general, in another aspect, pin electronics in accordance with the invention include a high speed signal path connecting an output of a comparator either to an input of a driver, to an external instrument, or to both the input of the driver and the external instrument. The output of the driver is connectable to a receive pin of a device under test. The input of the comparator is connectable either to a transmit pin of the device under test or to an external data source.

The invention can be implemented to realize one or more of the following advantages. A test system in accordance with the invention can support test configurations that are not available in conventional systems. For example, the system provides, during loop back testing, programmable and active input-voltage amplitude control of the stimulus signal, which control is not available with conventional solutions implemented on a load board.

The system allows a signal from an external data source, such as a jitter-injected data source, to be accurately inject into a DUT through the system's pin electronics while not sacrificing any DC testing. The system allows an external instrument, such as a jitter-measurement instrument, to measure jitter output accurately from the DUT while not sacrificing any DC testing and, furthermore, while allowing the system to strobe the output of the DUT if it is necessary to do so.

Because the system can strobe the DUT while an external instrument measures the DUT's jitter output, the system addresses the pair-making issue of good and bad transmit (“Tx”) and receive (“Rx”) or, alternatively, bad and good Tx and Rx. The pair-making issue is further described below. The term external, as used in this specification, generally refers to being external to the system. Devices that are detachably and temporarily coupled to the DUT during testing, even though they may be controlled by the system, are external devices. Special purpose devices that are built into the system after the production of the system can also be external devices. Devices, for example, the described jitter-measurement instrument and jitter-injected data source, that are detachably and temporarily coupled to the system are also external devices. Other examples of devices that can be coupled as external devices include oscillators and filters.

Although some of the test configurations mentioned above can be achieved by using relays and/or fanout devices and multiplexers on a load board, such a load board solution can sacrifice DC and AC test quality and require load board designers to design and implement high quality signal paths for timing-critical signals. The system described in this specification provides these signal paths without compromising test quality or routing signals with additional components such as high frequency relays, jumper cables, and active devices. DC and AC tests include continuity, voltage output high, voltage output low, input current high, and input current low tests.

The system addresses the effects of a limited frequency bandwidth of a DUT signal path. In serialcom link testing, effects of a limited frequency bandwidth of a DUT signal path can introduce a non-negligible amount of data dependent jitter in jitter testing. The term data dependent jitter (or “DDJ”) refers to data dependent timing error. As data rates increase, the frequency bandwidth effects become much more critical and the amount of DDJ becomes significant. The system compensates for the described increased DDJ. Data dependent jitter is further described in “Testing Gigabit Multilane SerDes Interfaces with Passive Jitter Injection Filters”, ITC Proceedings, pp297-305, 2001 by B. Laquai and Y. Cai (“Testing Gigabit”); “Test Challenges for SONET/SDH Physical Layer OC3 Devices and Beyond”, ITC Proceedings, pp 502-511, 2001, by Udaya Natarajan; and National Committee for Information Technology Standardization, T11.2/Project 1316-DT/Rev 4.0, “Fibre Channel-Methodology for Jitter and Signal Quality Specification”, Nov. 12, 2001.

The details of one or more implementations of the invention are set forth in the accompanying drawings and the description below. Other features, aspects, and advantages of the invention will become apparent from the description and the drawings.

### BRIEF DESCRIPTION OF THE DRAWINGS

FIG. 1 shows an example placement of pin electronics.

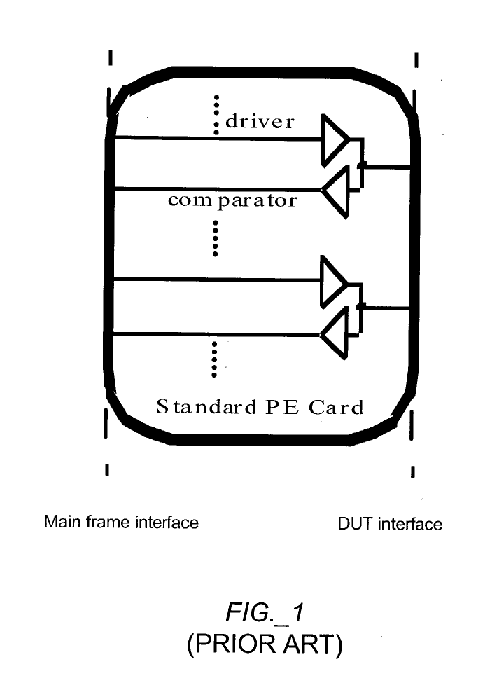

FIG. 2 shows a circuit test system in accordance with the invention.

FIG. 3 shows an implementation of high speed signal paths in pin electronics.

FIG. 4 shows example signal paths for transmit testing and receive testing.

FIG. 5 shows an example signal path for receive testing with external jitter injection and, furthermore, with input-voltage amplitude control.

FIG. 6 shows an example signal path for transmit testing with external jitter-measurement and, furthermore, with DUT strobing.

FIG. 7 shows an example loop back signal path for transmit and receive testing with input-voltage amplitude control.

FIG. 8 shows an example loop back signal path for transmit and receive testing input-voltage amplitude control and external jitter injection.

FIG. 9 shows another implementation of high speed signal paths in pin electronics.

FIG. 10 shows a method for configuring pin electronics.

FIG. 11 illustrates active compensation at a comparator.

Like reference numbers and designations in the various drawings indicate like elements.

### DETAILED DESCRIPTION

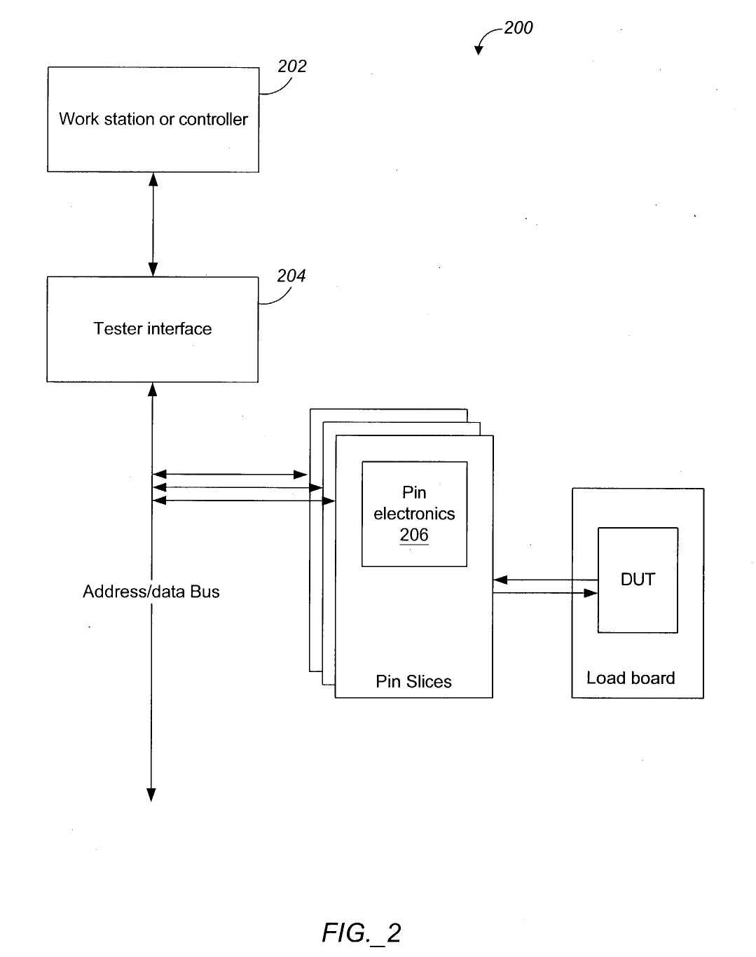

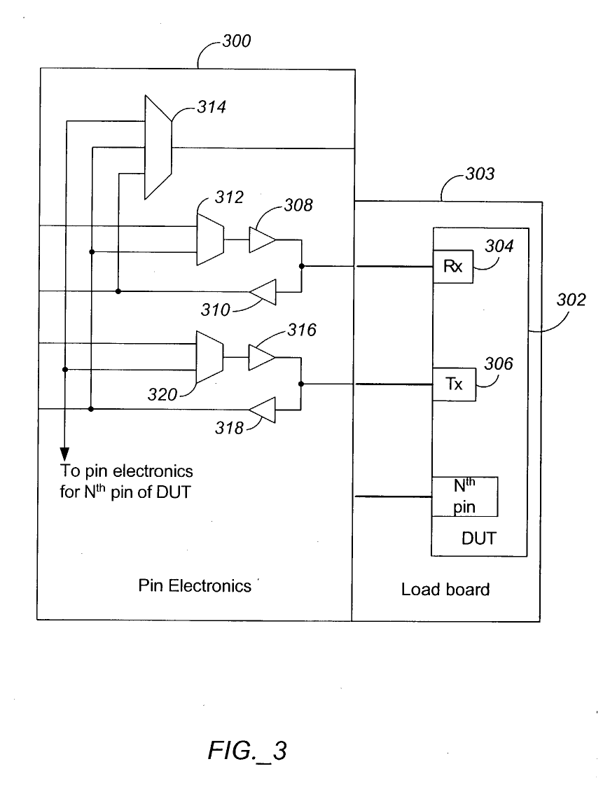

FIG. 2 shows a test system 200. The system 200 can be any system that performs testing on circuits, including IC automatic test equipment for testing electronic components having multiple pins. The system includes a workstation 202, a tester interface 204, and pin electronics 206 that includes a driver and comparator. The driver can be a high speed true differential driver and the comparator can be a high speed true differential comparator. The pin electronics 206 further includes high speed signal paths for various IC tests, for example, any combination of the following: jitter testing, loop back testing, standard transmit and receive testing, receive testing with external jitter injection and with input-voltage amplitude control, transmit testing with external jitter measurement, transmit and receive testing in loop back mode with input-voltage amplitude control, transmit and receive testing in loop back mode with input-voltage amplitude control and with external jitter injection. The signal paths for these particular tests are further described below in reference to FIGS. 3-8. The pin electronics can include other signal paths for other tests.

The pin electronics 206 can also include switching circuitry for switching from one signal path to another. The switching circuitry can also combine any of the signal paths described. The switching circuitry can include any high speed switching devices, which can be electrical or optical. The switching can include, for example, one or more multiplexers, one or more relays, or any combination of multiplexers and relays.

The term signal path, as used in this specification, refers to a path through which a signal, electrical, optical, or otherwise, can be routed. A signal path can include passive and active components. Making a signal path, as used in this specification, refers to establishing a path, either temporarily or permanently, through which a signal can be routed. Making a path can include, for example, closing an open switch in an otherwise established signal path. Shutting one open switch, for example, to establish an electrically conductive or an optically continuous path between nodes A and B would be considered as making a signal path between nodes A and B. Causing a multiplexer, for example, to route a signal between nodes A and B would also be considered as making a signal path between nodes A and B.

The workstation 202 generally controls the system and, furthermore, can include computer programs that determine which signals paths are needed for a particular test at a particular time during testing. The programs can include, for example, a look up table that associates particular signal paths with particular tests. Once the workstation determines which signal paths are needed, the workstation can select and send instructions to the switching circuitry to establish the appropriate signal paths at the appropriate time during testing. That is, the workstation can cause the switching circuitry to make signals paths in synchronization with the tests being performed on the DUT. The workstation can, for example, cause the switching circuitry to make a signal path for external jitter injection whenever external jitter injection is needed during testing. The workstation 202 can perform the described determination either before commencing or during testing.

There can be multiple levels of control. For example, the system 200 can include the described workstation, which is sometimes referred to as a general controller for the system, and one or more special purpose controllers, which can be implemented as field programmable gated arrays or microprocessors in the pin slice or the pin electronics circuitry. Each of the special purpose controllers can control different components of the system. For example, one special purpose controller can control the mentioned switching devices which can be, for example, multiplexers and relays. Another special purpose controller can control other components such as, for example, drivers and comparators of the pin electronics. The special purpose controllers operate in response to test programs that are usually executed by the test system. The system includes communication paths so that the special purpose controllers can communicate with the work station and also with the components they control. The communication paths are separate from the signal paths for transmitting and receiving signals to and from the DUT.

Test systems are further described in U.S. Pat. Nos. 5,673,275, 5,225,772, and 5,212,443. High speed pin electronics are further described in “Pin Electronics IC for High Speed Differential Devices”, ITC Proceedings, pp 1128-1133, 2001, by A. Oshima, J. Poniatowski, and T. Nomura. Jitter testing and loop back testing are further described in the Testing Gigabit reference and also in “Digital Serial Communication Device Testing and Its Implications on Automatic Test Equipment Architecture”, ITC Proceedings, pp 600-609, 2000, by Y.Cai, T. P. Warwick, S. G. Rane, and E. Masserrat.

FIG. 3 shows an implementation of the described switching circuitry and high speed signal paths, which can be configured to route the output of one comparator to either an input of a driver, to an input of an external instrument, or to both the driver input and the external instrument input. With this capability, the pin electronics 206 can support test configurations that can vary depending on factors such as device characteristics, protocol that the device uses, and whether the testing is for device characterization in design phase or for device testing during high volume manufacturing.

As shown, the pin electronics 206 are implemented on a pin electronics card 300. The DUT 302, which is mounted on a load board 303, is a serialcom device that includes an Rx pin 304 and a Tx pin 306. The pin electronics for the Rx pin 304 include a driver 308, a comparator 310, and a multiplexer 312. The output of the comparator 310 is routed to a multiplexer 314 that outputs to a node. The node is connectable to carry a signal to an external electronic device, for example, an external measurement device. The pin electronics for the Tx pin 306 includes a driver 316, a comparator 318, and a multiplexer 320. The output of the comparator 318 is routed to the multiplexer 314. In general, the pin electronics for other pins of the DUT 302 include components similar to those described. The output of the comparators of the pin electronics for other pins are also routed to the multiplexer 314. For example, the output of the comparator of the pin electronics for the N^{th} pin of the DUT 302 is routed to the N^{th} input of the multiplexer 314. The pin electronics card 300 can include pin electronics for other pins of the DUT. The pin electronics card 300 can, for example, include pin electronics for N number of pins. In the implementation described, the multiplexers provide the switching needed to switch signal paths. That is, the multiplexers are the switching circuitry. The multiplexers 312, 314, and 320 are configured to receive instructions from special purpose controllers and switch signal paths in accordance with those instructions. Alternatively, other devices such as, for example, switches and relays can be used to provide the switching.

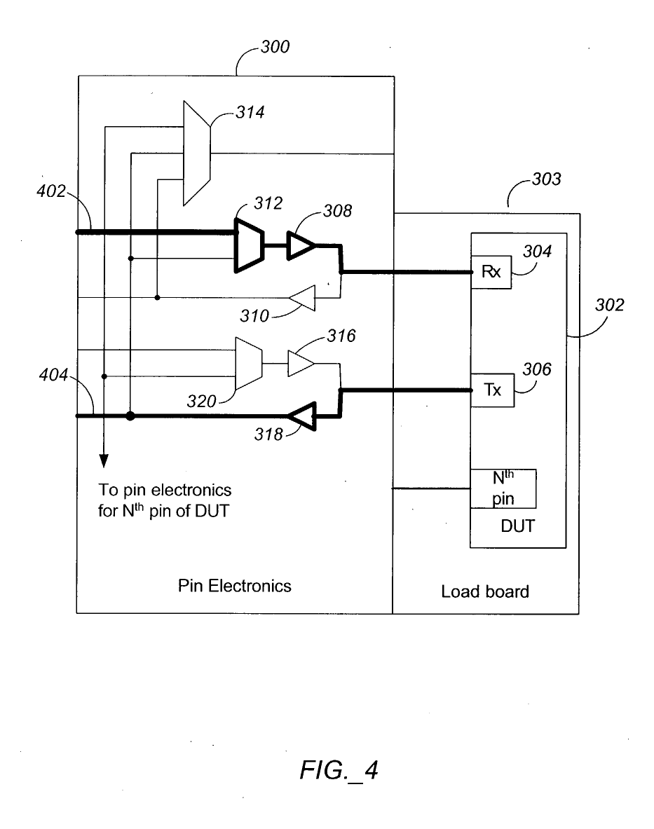

FIGS. 4 through 7 show examples of signal paths for various test configurations configured by the system from the circuitry shown in FIG. 3. FIG. 4 shows example signal paths for testing the transmit and receive functions of the DUT 302. The pin electronics card 300 can provide a signal path 402 for routing stimulus signals to the Rx pin 304 of the DUT 302. The signal path 402 includes the multiplexer 312, which the system cause to pass the stimulus signals, and the driver 308, which the system can control to change the amplitude, i.e., the voltage, of the stimulus signals. The system can include a signal source that generates stimulus signals. The system can also include internal jitter-injection components so that the stimulus signal being routed through the signal path 402 can have jitter injection when needed. In response to the stimulus signals, the DUT 302 transmits output signals from its transmit pin 306. The pin electronics can provide a signal path 404 for routing the DUT's output signal to an analyzer. The signal path 404 includes the comparator 318, which can strobe the output signal, compare it with a reference signal, and output the result of the comparison to an analyzer. The system can include internal jitter-measurement components so that the jitter of the output signal being routed through the signal path 404 can be measured.

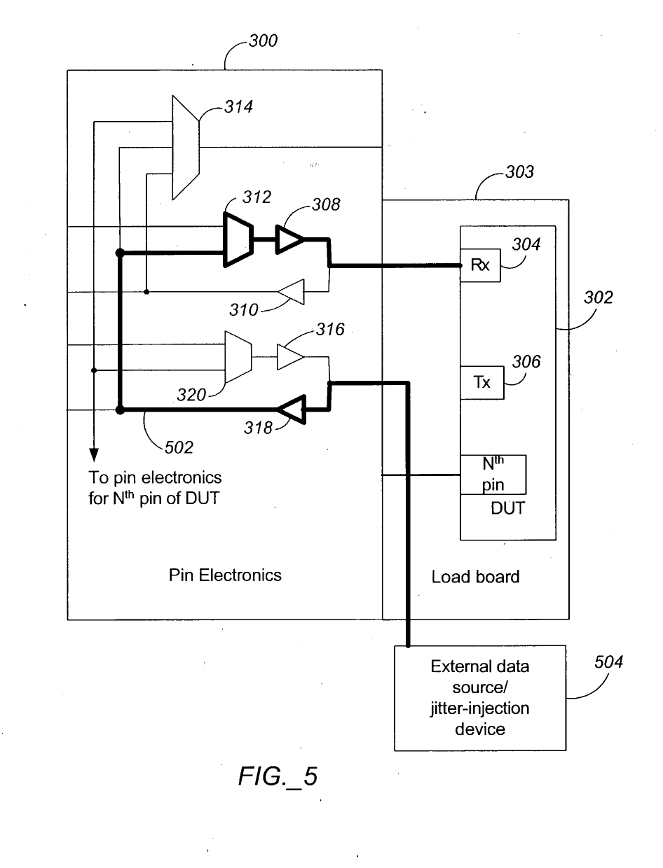

FIG. 5 shows an example signal path for receive testing with external data or jitter injection and with input-voltage amplitude control. External data source/jitter-injection devices can be used to generate and provide data and jitter not provided by system components. The pin electronics card 300 can provide a signal path 502 for routing a signal from an external data source/jitter-injection device to the Rx pin 304 of the DUT 302. The data source/jitter injection device can be connected through the load board 303. The signal path 502 includes the comparator 318, the multiplexer 312, and the driver 308. The system can cause an external data source, for example, a jitter-injected signal source instrument 504, to inject timing jitter very accurately to serial data and, furthermore, the driver 308 to change input voltage amplitude so that the opening of the eye diagram of the input signal to the DUT 302 can be controlled both horizontally and vertically. In this example, the comparator 318 acts as a buffer and provides programmable and variable threshold detection.

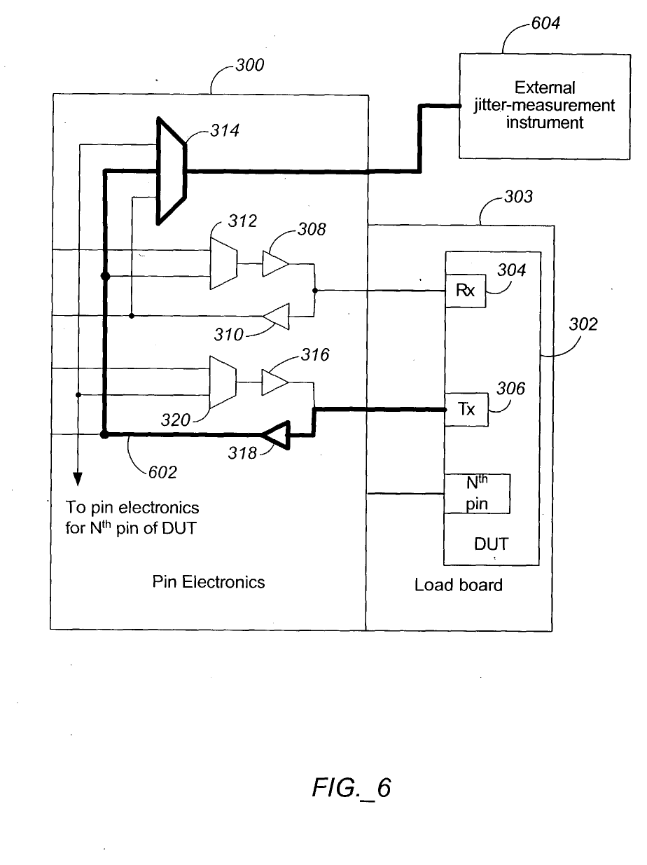

FIG. 6 shows an example signal path for transmit testing with an external jitter measurement instrument and, furthermore, with DUT strobing. External measurement devices can provide flexibility and improve accuracy over internal measurement components. The pin electronics card 300 can provide a signal path 602 for routing an output signal from the Tx pin 306 to an external measurement instrument, for example, a jitter measurement instrument 604. The signal path 602 includes the comparator 318 and the multiplexer 314. Because the signal path 602 is implemented on the pin electronics card 300, which usually includes DC testing and AC strobing capabilities, DC testing is not sacrificed for accurate jitter measurement and the system can strobe DUT output if it is necessary to do so.

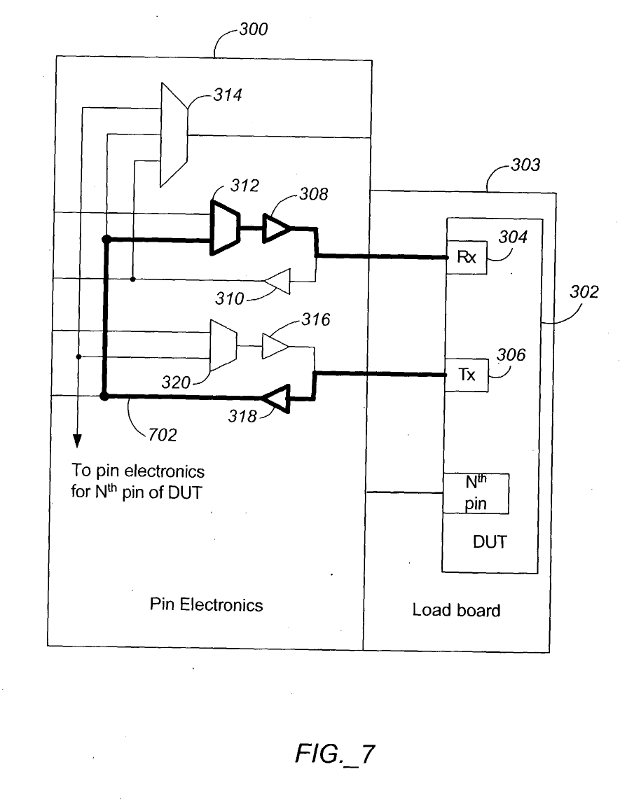

FIG. 7 shows an example loop back signal path for transmit and receive testing with input-voltage amplitude control. The pin electronics card 300 can provide a loop back signal path 702 for routing an output signal form the Tx pin 306 to the Rx pin 302. The signal path includes the comparator 318, the multiplexer 312, and the driver 308. The system can cause the driver 309 to change the amplitude of the input signal as described above.

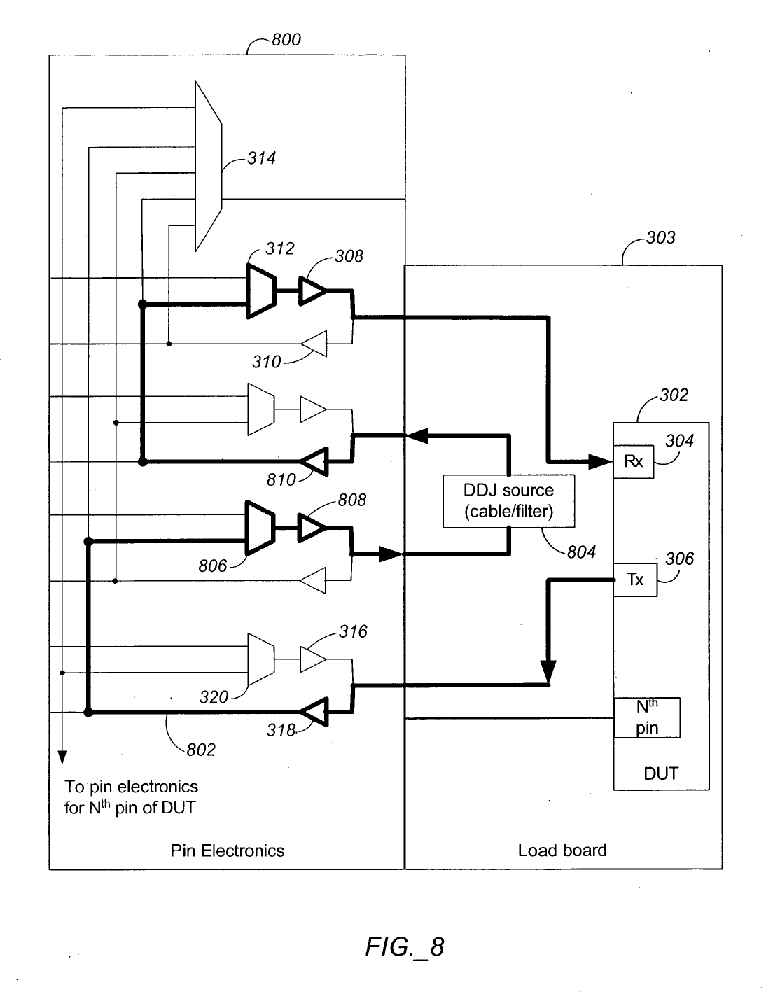

FIG. 8 shows an example loop back signal path for transmit and receive testing with input-voltage amplitude control and with data dependent jitter injection. A pin electronics card 800 can provide a loop back signal path 802 for routing an output signal from the Tx pin 306, through an external device, for example, a filter or a DDJ source 804, to the Rx pin 304. The external DDJ source 804 is shown as implemented on the load board 303 but, in alternative implementations, can be implemented off the load board. The signal path includes the comparator 318, the multiplexer 806, the driver 808, the comparator 810, the multiplexer 312, and the driver 308. A signal that is being routed to the Rx pin 304 through the signal path 802 can also be simultaneously routed through the multiplexer 314 to an input of an external measurement device, for example, an external jitter-measurement instrument. Because the DUT output can be strobed by the system, measured by the external jitter-measurement instrument, or be strobed and measured at the same time, the system can address the pair-making issue of good (bad) Tx and bad (good) Rx. For example, when a loop back signal from the transmit pin fails to reach the Rx pin, the system can determine if the problem is with the transmit function or the receive function of the DUT. The pair-making issue is further described in the Testing Gigabit reference.

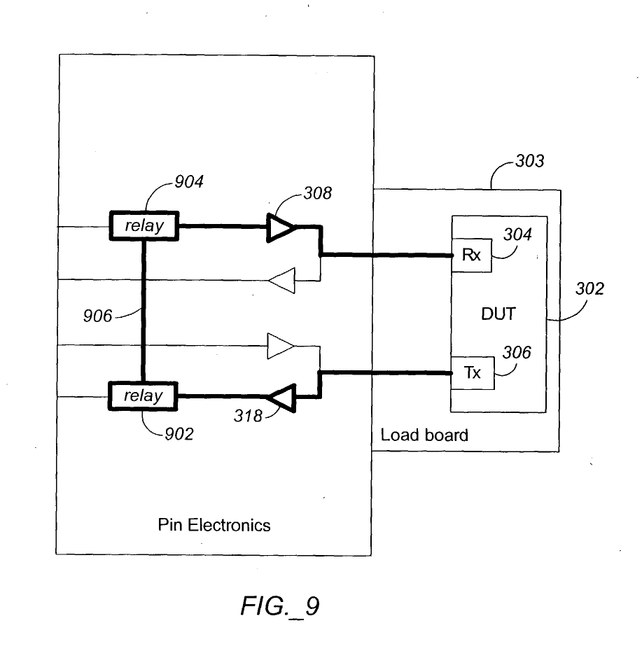

FIG. 9 shows another implementation of the switching circuitry and signal paths. In this implementation, the pin electronics 206 are implemented on a pin electronics card 900 and include relays 902 and 904. The system can control the relays to make a loop back signal path 906. The relays are located on the tester side of the pin electronics drivers and comparators to provide a capability to control input voltage amplitude and to strobe. The relays can alternatively be located on the DUT side of the drivers and comparators.

The pin electronics 206 can optionally include a relay for routing an output signal from the DUT to any of the resources available on the tester such as, for example, the DC/AC testing components usually included in a pin slice.

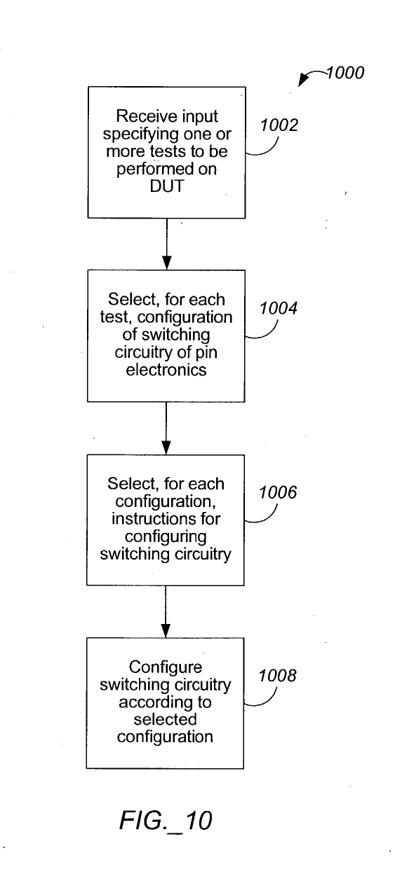

FIG. 10 shows a method 1000 for configuring pin electronics. A system performing the method 1000 receives input that specify one or more tests to be performed on a DUT (step 1002). The input can be from a human operator or a computer program. The system selects, for each test, a configuration of switching circuitry of the pin electronics (step 1004). The configuration of the switching circuitry can provide signal paths for any combination of the following tests features: loop back, a capability to control input voltage amplitude, a data dependent jitter injection, external jitter measurement, and external filtration. The system selects, for each configuration, instructions for configuring the switching circuitry (step 1006). The instructions for configuring the switching circuitry can include instructions for operating at least one of a multiplexer and a switch. The switch can be a relay. The instructions can also include instructions for operating other switching circuitry components. The system configures the switching circuitry according to the selected configuration (step 1008).

There are many parameters to consider to implement the described signal paths on pin electronics, such as additional jitter due to active devices, transmission line impedance control, frequency bandwidth, reflection, and crosstalk. One key factor is frequency bandwidth of the signal paths. The frequency bandwidth must be sufficiently wide to ensure accurate testing. Calculating an appropriate frequency bandwidth is further discussed in Masashi Shimanouchi, “New Signal Paths for Serialcom Device Testing and Frequency Bandwidth Studies,” ITC Proceedings, pp. 903-912, 2002 (“New Signal Paths”).

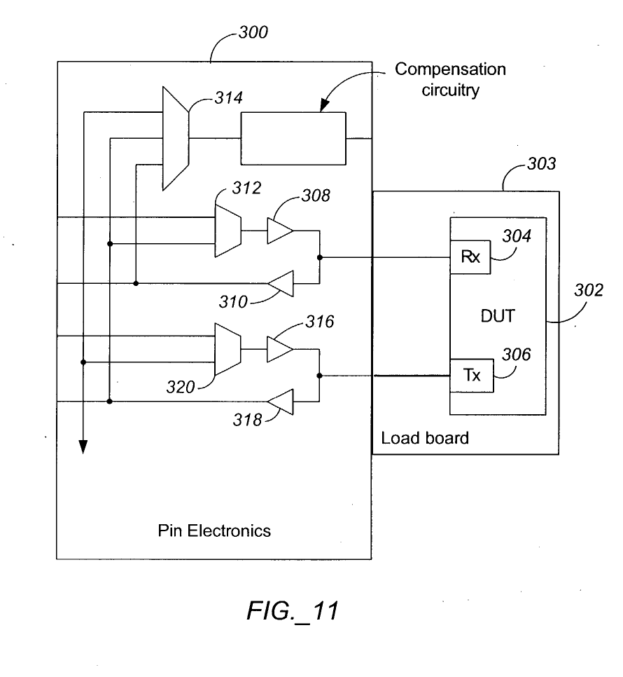

The pin electronics 206 can optionally include compensation circuitry that compensates for signal loss, cable/printed circuit board (“PCB”) trace loss, as well as other losses, and thereby reduce data dependent timing errors. Signal loss can be caused by signal paths having insufficiently wide frequency bandwidth. Cable/PCB trace loss can result from skin effect and dielectric losses. In one implementation, the system can include compensation circuitry in series with a lossy transmission line as illustrated in FIG. 11. Compensation is also further described in the New Signal Paths reference.

Various aspects of the invention, including the method steps described, can be implemented as a computer program product, i.e., a computer program tangibly embodied in an information carrier, e.g., in a machine-readable storage device, for execution by, or to control the operation of, data processing apparatus, e.g., a programmable processor, a computer, multiple computers, or a test system. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks.

Information carriers suitable for embodying computer program instructions and data include all forms of non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks. The processor and the memory can be supplemented by, or incorporated in special purpose logic circuitry.

The invention has been described in terms of particular implementations. Other implementations are possible. For example, the steps of the invention can be performed in a different order and still achieve desirable results. The pin electronics described need not be located in a test head. There are implementations, for example, in which the pin electronics are incorporated into the main frame of the system and there is no test head. The described switching circuitry and signal paths need not be implemented in pin electronics but, rather, can be implemented anywhere in the system where a driver. used to stimulate the DUT and comparator used to detect output signals from the DUT are located. The switching circuitry and signal paths described can be implemented on either the tester side or the DUT side of the driver and comparator. While serialcom devices were described, the invention is applicable to any device that can benefit from loop back testing or injection of data to and from external devices. These devices include those having high data rates. Examples include but are not limited to those that operate in accordance with XAUI, FIBRE Channel, or OC48 protocols. Any combination and type of multiplexers can be used to effectuate the new signal paths described and it is not necessary to use only those multiplexers shown in the figures. The described jitter-injection devices can also be data sources. The pin electronics card described can include pin electronics for more than the number of pins shown in the examples.

What is claimed is:

1. Circuitry for use in testing electronic circuits, comprising:
switching circuitry operable to be controlled to make one of a first signal path and a second signal path, the first signal path being configured to carry a signal between a first node and a second node, the second signal path being configured to carry a signal between the first node and a third node, each of the signal paths including a portion that is located in pin electronics, the first node being connectable to a first pin of a device under test, the second node being connectable to a second pin of a device under test, and the third node being connectable to an electronic instrument.

2. The circuitry of claim 1, wherein:
the first signal path includes a driver coupled to output to the second node and configured to stimulate the device under test when the second pin of the device under test is connected to the second node.

3. The circuitry of claim 1, wherein:
the switching circuitry is further operable to make a third signal path that is configured to carry a signal from the first node to both the second and the third nodes.

4. The circuitry of claim 3, wherein the switching circuitry includes:
at least one of a multiplexer and a switch, each being operable to be controlled to route a signal.

5. The circuitry of claim 4, wherein:
the at least one of a multiplexer and a switch includes a first relay and a second relay, the relays being operable to make a signal path between the first node and the second node.

6. The circuitry of claim 4, wherein:
the at least one of a multiplexer and a switch includes a relay that is operable to make a signal path between one of the nodes and a direct current measurement instrument.

7. The circuitry of claim 3, wherein:
the first node is connectable to a transmit pin of the device under test;
the second node is connectable to a receive pin of the device under test;
the driver is operable to change a signal being looped back from the first pin to the second pin.

8. The circuitry of claim 7, wherein:
the first signal path includes a comparator; and
the driver and comparator are operable to change one of an amplitude, a time shift, and both the amplitude and time shift of the signal being looped back.

9. The circuitry of claim 3, wherein:
the first node is connectable to a transmit pin of the device under test;
the second node is connectable to a receive pin of the device under test; and
the switching circuitry includes a first multiplexer that is operable to make the first signal path or a third signal path that electrically connects the second node and a signal source of a tester.

10. The circuitry of claim 3, wherein:
the third node is connectable to a measurement instrument; and
the switching circuitry includes a second multiplexer that is operable to make a third signal path between the third node and another node that is connectable to a pin of the device under test.

11. The circuitry of claim 10, wherein:
the third signal path includes a comparator that is configured to detect output signals from the device under test when the first pin of the device under test is connected to the first node.

12. The circuitry of claim 3, wherein:
the switching circuitry is further operable to make a third signal path between a fourth node and a fifth node, the fourth node and fifth node being configured to be electrically connected to an electrical device; and
the circuitry is operable to connect and disconnect the electrical device to and from, respectively, the circuitry.

13. The circuitry of claim 12, wherein:
the electrical device is a filter.

14. The circuitry of claim 13, wherein:
the first node is connectable to a transmit pin;
the second node is connectable to a receive pin;
the third signal path is included in the first signal path; and
the first signal path provides a signal path for a loop back test with data dependent jitter injection.

15. The circuitry of claim 3, wherein:
the first node is connectable to a transmit pin of the device under test;
the second node is connectable to a receive pin of the device under test; and
the circuitry is further operable to make a third signal path and a fourth signal path, the third signal path being between the first node and an analyzer, and the fourth signal path being between a signal source and the second node.

16. The circuitry of claim 1, wherein:
the electronic device is a signal injection instrument and the first node is connectable to a receive pin of the device under test.

17. The circuitry of claim 1, wherein the second conducting connection includes:
one of an active compensation circuit and a passive compensation circuit.

18. The circuitry of claim 1, wherein:
the switching circuitry is configured to operate in response to computer program control.

19. The circuitry of claim 1, wherein:
the switching circuitry is high speed.

20. The circuitry of claim 1, wherein:
the signal path is high speed.

21. A computer-implemented method for configuring pin electronics, comprising:
receiving input that specify one or more tests;
selecting, for each test, a configuration of a switching circuitry of the pin electronics, the configuration being any combination of a loop back configuration, a voltage leveling configuration, a jitter measurement configuration, and a jitter injected configuration; and
configuring the switching circuitry according to the selected configuration.

22. A computer program product, tangibly embodied in any combination of a machine-readable medium and a propagated carrier signal, for controlling pin electronic circuitry, comprising instructions operable to cause the pin electronic circuitry to:
receive input that specify one or more tests;
select, for each test, a configuration of a switching circuitry of the pin electronics, the configuration being any combination of a loop back configuration, a voltage leveling configuration, a jitter measurement configuration, and a jitter injected configuration; and
configure the switching circuitry to the selected configuration.
